(19) United States
(12) Patent Application Publication
(10) Pub. No.: US 2019/0114373 A1
(43) Pub. Date: Apr. 18, 2019

(54) SCALABLE CANDIDATE SELECTION FOR RECOMMENDATIONS

(71) Applicant: Facebook, Inc., Menlo Park, CA (US)

(72) Inventors: Karthik Subbian, Cupertino, CA (US); Sergey Edunov, Menlo Park, CA (US)

(21) Appl. No.: 15/783,984

(22) Filed: Oct. 13, 2017

(51) Int. Cl. G06F 17/30; H04L 12/58; G06N 5/04

(52) U.S. Cl. CPC G06F 17/30991; H04L 51/32; G06F 3/0482; G06N 5/046; G06F 17/30864

(57) ABSTRACT

In one embodiment, a method includes identifying a first user node that corresponds to a first user of a social-networking system for whom recommendation candidates are to be generated, where the social-networking system comprises a social graph that comprises nodes and edges representing relationships between the users. The method further includes performing one or more steps of a computation that implements a random walk of the nodes of a social graph, and generates a ranking value for each user node that satisfies one or more constraints, wherein the ranking value represents an importance of the user node to other user nodes in the social graph in accordance with the relationships represented by the edges, and selecting one or more candidate users to be recommended to a particular user based on the ranking values associated with the user nodes.

### TECHNICAL FIELD

This disclosure generally relates information retrieval, and more particularly to selecting candidates for recommendation to users.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, a user recommendation system may recommend one or more users for a particular user to follow or friend in an online social network. The users to be recommended may be identified and ranked using a Personalized Rank (“PR”) technique, which may generate a ranking of the importance of selected user nodes in a social graph to the particular user according to the structure of follower or friend links in the social graph. The ranking may be generated using an implementation of a random walk of the social graph's user nodes. Constraints may be associated with the user nodes, and rankings need not be generated for user nodes that do not satisfy their associated constraints. For example, the social-networking system may assist certain users, referred to as “needy users,” with establishing relationships or distributing content. Needy users may include users who have had an account with the social networking system for less than a threshold amount of time or have less than a threshold number of connections to other users. Constraints may be used to include such users in the rankings while excluding other users. As another example, when the random walk implementation generates ranking values at each user node for other users, the number of ranking values for other users stored at each user node may be limited, e.g., to at most a threshold number of the highest ranking users. Using constraints to reduce the number of users who are evaluated and/or using a threshold limit to reduce the number of evaluated users for whom ranking values are stored may substantially reduce the execution time and storage resources used in generating recommendations based on random walks of the social graph.

The ranking of users generated by the random-walk technique may be presented to the particular user as a list of recommended users, or may be passed as a set of candidate users to a trained recommendation model, such as a logistic regression model, which may predict a likelihood of each candidate user being followed or friended. Candidate users having at least a threshold likelihood of being followed or friended may then be presented to the particular user.

### BRIEF DESCRIPTION OF THE DRAWINGS

FIGS. 1A-1F illustrate execution of an example method for selecting candidate users for recommendation.

FIGS. 2A-2F illustrate execution of an example method for selecting candidate users for recommendation using constraints.

FIG. 3 illustrates an example method for selecting candidate users for recommendation using constraints.

FIG. 4 illustrates an example network environment associated with a social-networking system.

FIG. 5 illustrates an example social graph.

FIG. 6 illustrates an example computer system.

### DESCRIPTION OF EXAMPLE EMBODIMENTS

In particular embodiments, a user recommendation system may recommend one or more users for a particular user to follow or friend in an online social network. The users to be recommended may be identified and ranked using a Personalized Rank (“PR”) technique, which may generate a ranking of the importance of selected user nodes in a social graph to the particular user according to the structure of follower or friend links in the social graph. The ranking may be generated using an implementation of a random walk of the social graph's user nodes. Constraints may be associated with the user nodes, and rankings need not be generated for user nodes that do not satisfy their associated constraints. For example, the social-networking system may assist certain users, referred to as “needy users,” with establishing relationships or distributing content. Needy users may include users who have had an account with the social networking system for less than a threshold amount of time or have less than a threshold number of connections to other users. Constraints may be used to include such users in the rankings while excluding other users. As another example, when the random walk implementation generates ranking values at each user node for other users, the number of ranking values for other users stored at each user node may be limited, e.g., to at most a threshold number of the highest ranking users. Using constraints to reduce the number of users who are evaluated and/or using a threshold limit to reduce the number of evaluated users for whom ranking values are stored may substantially reduce the execution time and storage resources used in generating recommendations based on random walks of the social graph.

The ranking of users generated by the random-walk technique may be presented to the particular user as a list of recommended users, or may be passed as a set of candidate users to a trained recommendation model, such as a logistic regression model, which may predict a likelihood of each candidate user being followed or friended. Candidate users having at least a threshold likelihood of being followed or friended may then be presented to the particular user.

Existing candidate selection strategies include selecting a random set of users and identifying users in the random set who are relevant to the given user. The relevant users may be those who are most liked or most shared, for example. As another example, the relevant users may be those who are indirectly connected to the given user. These strategies may work for candidates that have had sufficient interactions, such as likes or shares, but do not work well for other types of candidates, such as new users or users who are less engaged (e.g., do not often like or share and/or lacks a sizeable network).

In particular embodiments, a social graph 500 may include nodes 502 that represent users or entities, and edges 506 that represent friend or follower relationships between the users. The edges may initially be directed from the follower node to the node of the user being followed, and may be reversed prior to performing the random walk. If the edges are undirected, e.g., as may be the case for friend relationships, directions may be arbitrarily assigned to the edges, or a direction may be assigned to each edge based on a property of the corresponding relationship. For example, a friend edge may be assigned a direction from the user who initiated a friend request to a user who received and accepted the friend request.

In particular embodiments, a random walk of a social graph may traverse the graph nodes by selecting a node, then traversing a randomly-selected one of the node's outgoing edges to an adjacent node, and repeating the random edge selection and traversal. At a particular node, each outgoing edge of the node may have an equal probability of being selected. This traversal process may generate a probability distribution of the traversed nodes. The random walk may eventually converge on a probability distribution if the graph satisfies certain properties. The probability distribution on which the random walk converges is referred to as a stationary distribution. The stationary distribution may be interpreted as, for each node, the probability of being at the node if the random walk were to be run for an infinite number of steps. The probability associated with each node in the stationary distribution may be interpreted as a ranking of the node's importance relative to other nodes according to the link structure of the graph. The stationary distribution may be used to identify candidate users to be recommended, or at least further evaluated for recommendation as users that the particular user may wish to friend or follow.

However, random walks implemented as graph traversals may be difficult to scale to large graphs, such as social graphs in online social networks. The Personalized Rank algorithm may be used to implement random walks by introducing a “teleport” probability, which is a threshold probability that the random walk jumps to a random node instead of following an edge to an adjacent node. Personalized Rank may be implemented as an iterative process using a power iteration technique that converges relatively quickly. Using power iteration, vectors of counts may be computed iteratively for each user node that is adjacent to the initial user node. Each element of a vector may be a count associated with a particular user node. Personalized Rank may generate an approximation of a random walk, and the approximation may become more accurate as the n umber of iterations increases.

Personalized Rank may be understood as restarting at the particular user's node with a probability given by the teleport probability (instead of restarting at a random node). That is, for a teleport probability “c”, at each user node, the random walk may, with a probability c, restart at the initial user node or, with a probability (1−c), select one of the user node's outgoing edges at random and follow the randomly-selected edge to another user node. The quantity (1−c) may be referred to as a damping factor. In particular embodiments, Personalized Rank may be understood as the stationary distribution of a random walk that at each step, with a teleport probability c, jumps to a randomly-selected node, and with probability (1−c), follows a randomly-selected outgoing edge from the current node. The randomly-selected node may be any user node selected at random from the social graph. In particular embodiments, the randomly-selected node may be any user node for which associated constraints are satisfied. The random jumps may be made back to the same node, denoted as the “source” or “seed” node, which may be a node that corresponds to the particular user for whom recommendations are being generated. The distribution may be represented as a vector with an entry for each node indicating how many times that node has been visited. The distribution is referred to herein as a Personalized Rank vector (“PRV”) of the initial user node.

In particular embodiments, the Personalized Rank computation may use constraints on nodes (or edges) to reduce the size of the computation. In this way, recommendations may be generated in near-real-time. For example, the constraints may cause needy users to be included in the computation, and cause non-needy users to be excluded from the computation. A needy user may be a user whom the social-networking system has determined to assist with establishing relationships or distribution of content. As another example, a needy user may be a user who has had an account with the social networking system for less than a threshold amount of time, has less than a threshold number of connections to other users, or is associated with less than a threshold number of stories, e.g., has posted or submitted less than a threshold number of content items, such as articles, messages, photos, or other items of content. Further details related to needy users are disclosed in U.S. patent application Ser. No. 13/716,012, entitled “Boosting Ranks of Stories by a Needy User on a Social Networking System” and filed 14 Dec. 2012, which is incorporated herein by reference as an example and not by way of limitation. The threshold number of content items may be, e.g., 10, 25, 50, or the like. Alternatively or in addition to using the constraints, at each node, the number of ranking values (e.g., PRV vector entries) may be limited, so a most the top-K ranking values at each node are retained.

In particular embodiments, the PRV vector of a “source” user node “s” may be calculated in a scalable manner using an iterative, message-passing-oriented computation in which, in each step, data, such as PRV vector entries, are exchanged between adjacent nodes but not between non-adjacent nodes. The PRV vector of a node “s” is abbreviated as “PRV at node s” and contains elements (e.g., numeric values) that correspond to node s and to other nodes “u” in the graph for which values have been determined. The term “at” is not meant to imply that the PRV is stored at a particular location. The numeric value of each element PRV(u) in the PRV vector at a node s characterizes the relative importance of a node u, which corresponds to the element, to node s. That is, at node s, each element PRV(u) of the PRV vector characterizes the relative importance of node u to node s. The PRV vector element that corresponds to node u is referred to herein as PRV(u). When s and u are both user nodes, the value of PRV(u) at node s represents the relative importance of user u to user s.

In particular embodiments, at a node s, the PRV vector element PRV(u) for any node u can be computed as a linear combination of the Personalized Ranks of its neighbors. Thus, for a user represented by a user node u, the Personalized Rank of a node u, denoted as PRV(u), may be computed based on a sum of the Personalized Rank values PRV(v) computed for each of node u's neighbor nodes v, according to a formula referred to herein as the PRV formula, as follows:

$$\vec{PRV} ( u ) = c * \vec{{δ}_{u}} + ( 1 - c ) \frac{1}{\vert N ( u ) \vert} {\sum }_{v ∈ N ( u )} \vec{PRV} ( v )$$

where δᵤ is a vector with entry u=1 and other entries=0. That is, the first term may add the teleport probability c to the second term. The Personalized Rank may be computed for each user in a social network by computing vector PRV for each user node u in the graph. In particular embodiments, the number of recommendations may be limited by a number K, so only the top-K values of each PRV vector need be determined.

In particular embodiments, to provide scalability, PRV values may be exchanged directly between neighbor nodes, but not directly exchanged between non-neighbor nodes. The calculation may be distributed across two or more processors that can compute PRV values in parallel. Each node may have one or more processors, which may perform calculations for PRV values at that node. Processors on different nodes may communicate, e.g., via messages. Communication between processors located on different nodes may be via a network or other type of inter-node communication. The PRV values at a particular node being calculated using the processor(s) located on that node. The calculated values may be sent among communication links between neighbor nodes that are located on different processors.

In particular embodiments, the PRV for each node may be iteratively updated based on the node's neighbor nodes, whose PRVs may also be iteratively updated based on their neighbor nodes. This iterative process causes PRV values to be propagated through the graph. Once the iterative process terminates, the PRV vector of a node u may identify one or more other nodes (e.g., nodes v) and each of their corresponding PRV values. For example, the PRV vector for node u, containing values for other nodes relative to node u, may include the values {node_x: 0.15, node_y: 0.255, node₁₃ z: 0.255}, indicating that nodes y and z may be better candidates than node x for user u. The notation {x: N} represents the PRV vector having the value P in the vector element that corresponds to node x.

[24] In particular embodiments, the direction of the graph edges may be reversed before the computation begins. For example, if the graph is a follower graph, then each edge from u to v indicates that u follows v. However, in the PRV computation, values may be sent in the opposite direction, from v to u, so the computation is more easily performed and understood when the edges are reversed. The localized nature of the PRV calculation contributes to the scalability of the Personalized Rank technique for generating recommendations. Other techniques for computing PRV values, such as Monte-Carlo methods, may be used instead of the example iterative power method described.

In particular embodiments, as introduced above, when the number of recommended users to be identified is limited, e.g., by a value K, only the top-K Personalized Rank vector values (PRV values) need be retained at each node. The value of K may be, e.g., 20, 50, 100, or other appropriate value. In particular embodiments, the PRV values for highest-ranked user nodes, e.g., the top-K ranked nodes, may be used as input to the recommendation model, and PRV values for nodes ranked below K may be discarded at each step. For example, if K=3, e.g., the top 3 values are to be retained at each node, then for a node having the values 0.2, 0.6, 0.3, 0.5, 0.9, the top 3 values, which are 0.9, 0.6, and 0.5, are retained at least until the next iteration, and the remaining values, 0.3 and 0.2, are discarded (e.g., deleted from memory). As an example, to identify the top-K values at each node, the PRV values at the node may be sorted in descending order to form a list, and the first K elements of the sorted list, which are the top-K values, may be retained. If there are fewer than K entries in the list, then all elements in the list may be retrained. The remaining elements, e.g., elements after the first K elements, may be discarded.

The Personalized Rank may be computed iteratively, where the value of PRV(u) at iterative step i is based on the value of the previous iteration i-1 based on the PRV formula, as follows:

$${\vec{PRV} ( u )}^{( i )} = c * \vec{{δ}_{u}} + ( 1 - c ) \frac{1}{\vert N ( u ) \vert} {\sum }_{\{ v \vert ( u , v ) ∈ E \}} {\vec{PRV} ( v )}^{( i - 1 )}$$

where δᵤ is a vector with entry u=1 and other entries=0. That is, the first term may add the teleport probability to the second term.

[27] In particular embodiments, initial values for iteration 0 may be set to 0. At the beginning of the computation, the initial value each PRV entry is set to the first term, e.g., teleportation probability c (e.g., 0.15). In particular embodiments, the top-K values in a PRV vector at each node may be retained after each iteration. The number of iterations may be 5, 20, or other appropriate number. The computation may be run until it converges, but a limited number of iterations (e.g., 3, 5, or 10), without necessarily running to convergence, may be sufficient in practice.

To reduce the time and memory used by the computation, constraints may be associated with the nodes or edges. Each constraint may be a condition that evaluates to true or false, and may be associated with one or more nodes and/or one or more edges of the graph. If a constraint evaluates to false, then the PRV for the constraint's node is not calculated and is not sent to other nodes. The constraint's node may continue to receive and send PRVs of other nodes, however.

A constraint associated with a particular node may use information associated with the node. Constraints may be based on user-related information, such as the length of time the user has been a member of the social-networking system, or may be based on the generated PRV values. For example, the constraint associated with a user node may specify that the user represented by the user node should be a new user of the social network, e.g., a user who joined less than 30 days ago. If the user represented by that user node joined less than 30 days ago, then the PRV value is calculated for that node and sent to neighbor nodes (which may subsequently send that node's PRV value to their neighbors in the next step, and so on in each subsequent step). A particular constraint may be associated with all nodes, in which case the constraint is evaluated at each node, or with a particular node, in which case the constraint is evaluated at the particular node but not at others.

In particular embodiments, constraints based on user-related information but not on PRV values may be computed when the user-related information changes, which is ordinarily infrequent. Such constraints may be evaluated prior to the first iteration as a pre-processing step to remove unnecessary nodes and edges, and whenever information that they depend on changes. Thus, when a constraint is changed, e.g., a constraint condition is changed, or when updates are made to the graph, e.g., when a user node is added or removed, the PRV values may be updated by performing another iteration based on the new graph. If there are constraints based on user-related information, then another step may be performed to re-evaluate affected constraints when the user-related information changes. Since each iteration uses data from the previous iteration and from the neighbors, when new nodes are introduced, their PRV value is initialized to a value based on their neighbors' most recent PRV values. As an alternative to performing another step when information changes, the PRV computation may be run periodically, e.g., every 2, 5, 12, or 24 hours, or the like.

If constraints are not used, each PRV vector may include an entry for each node on the graph for which there is a path from v to u of sufficiently short length (e.g., length less than or equal to the number of iterations that have been executed). However, PRV vectors need not include entries for nodes that fail constraint checks, so PRV values need not be computed for those nodes. The nodes that do not satisfy the constraints may remain in the graph for the purposes of maintaining and/or calculating vector elements for other nodes and sending messages between other nodes.

In particular embodiments, as introduced above, constraints may be used to select candidate users who are new users, so that, for example, friends may be found for new users. Such a “new user” constraint may be satisfied by nodes that correspond to users who joined the social network less than a threshold time in the past. The threshold time may be, e.g., 30 days, 6 months, 1 year, or other appropriate length of time.

In particular embodiments, constraints may also be used to select candidate users who are not well-known, since well-known users, e.g., Taylor Swift, are likely already known to the given user, and also are likely to have many friends or followers. Such a “not famous” constraint may be satisfied by nodes that correspond to users who have fewer than a threshold number of followers or friends. The threshold number of followers or friends may be, e.g., 10, 25, 50, 100, 200, or other suitable number.

In particular embodiments, constraints may be used to select users based on weights associated with edges between the users' user nodes. A weight may represent a number of interactions. As an example, the edge weight may be based on a number of likes. If user 1 likes user 2 (or vice versa) then the weight of the edge between the nodes that correspond to user 1 and user 2 may be greater than the weight of edges between nodes of other users related by fewer likes.

Because of its scalability features, such as retaining the top-K PRV vector elements at each node at each step, and excluding nodes that do not satisfy constraints, the Personalized Rank calculation of candidate users may be performed in real-time or near real-time. The calculation may be run one or more times per day to update the PRV element values for every node in a social graph based on the most recent nodes and edges in the social graph. Each run of the computation may use the previous run's data as input, so each run may continue a computation from a previous run.

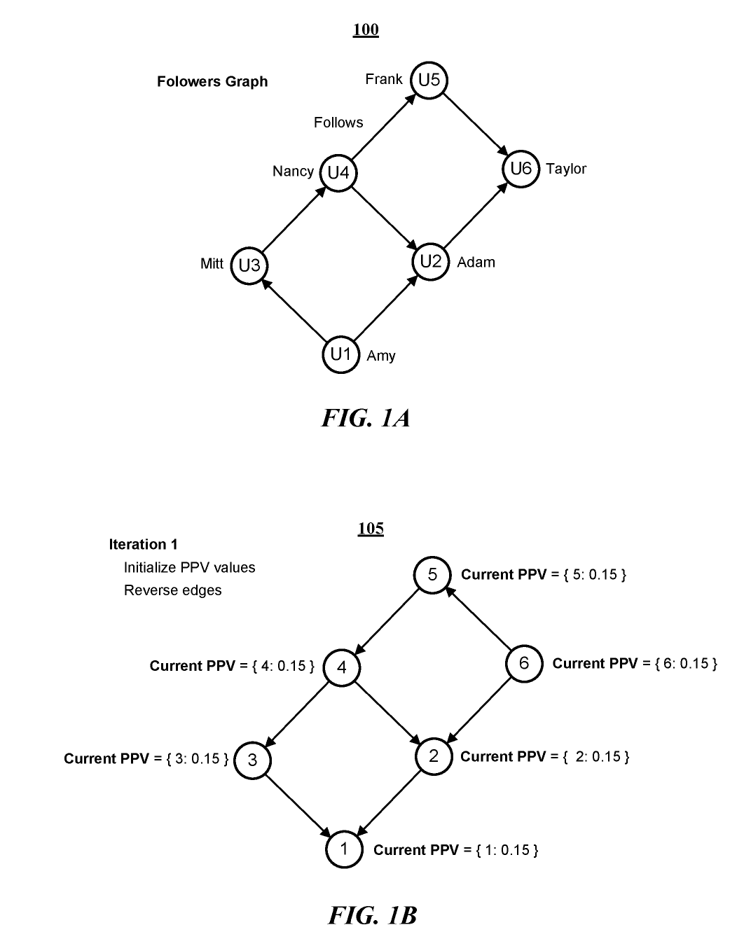

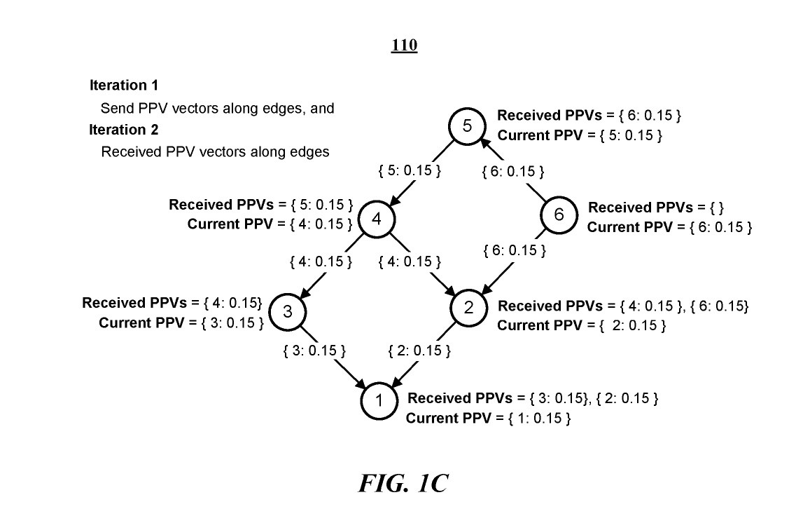

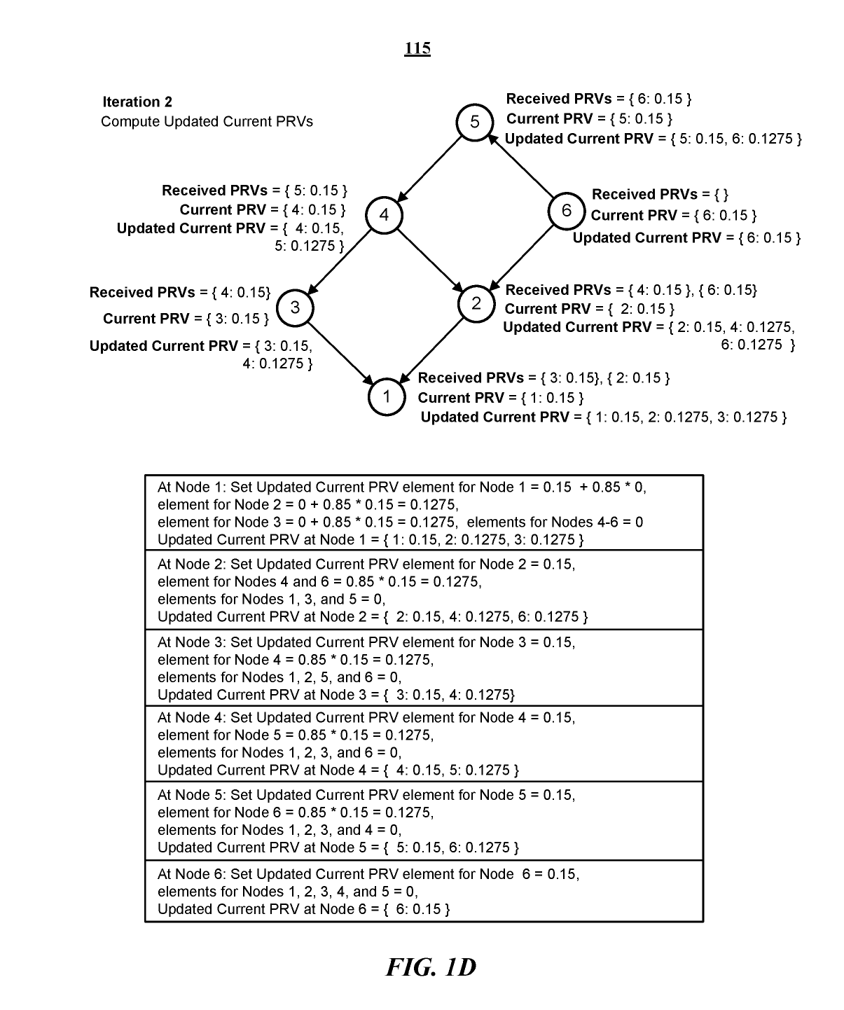

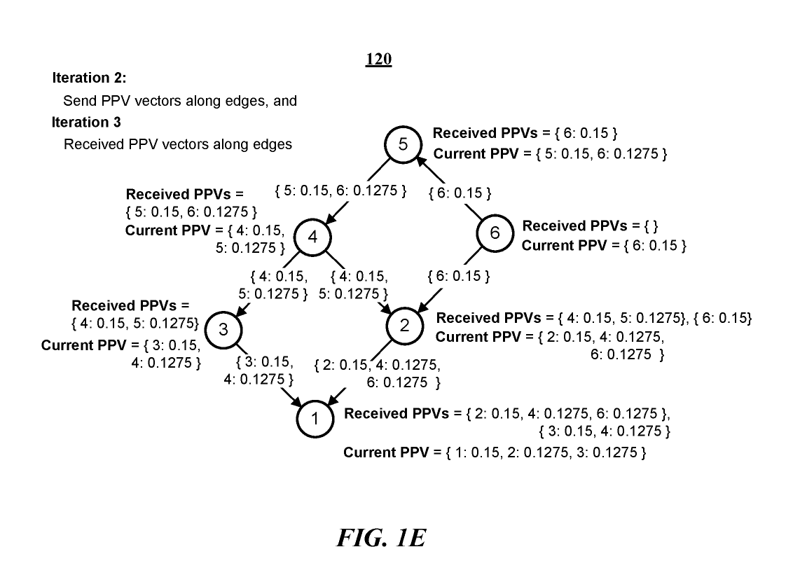

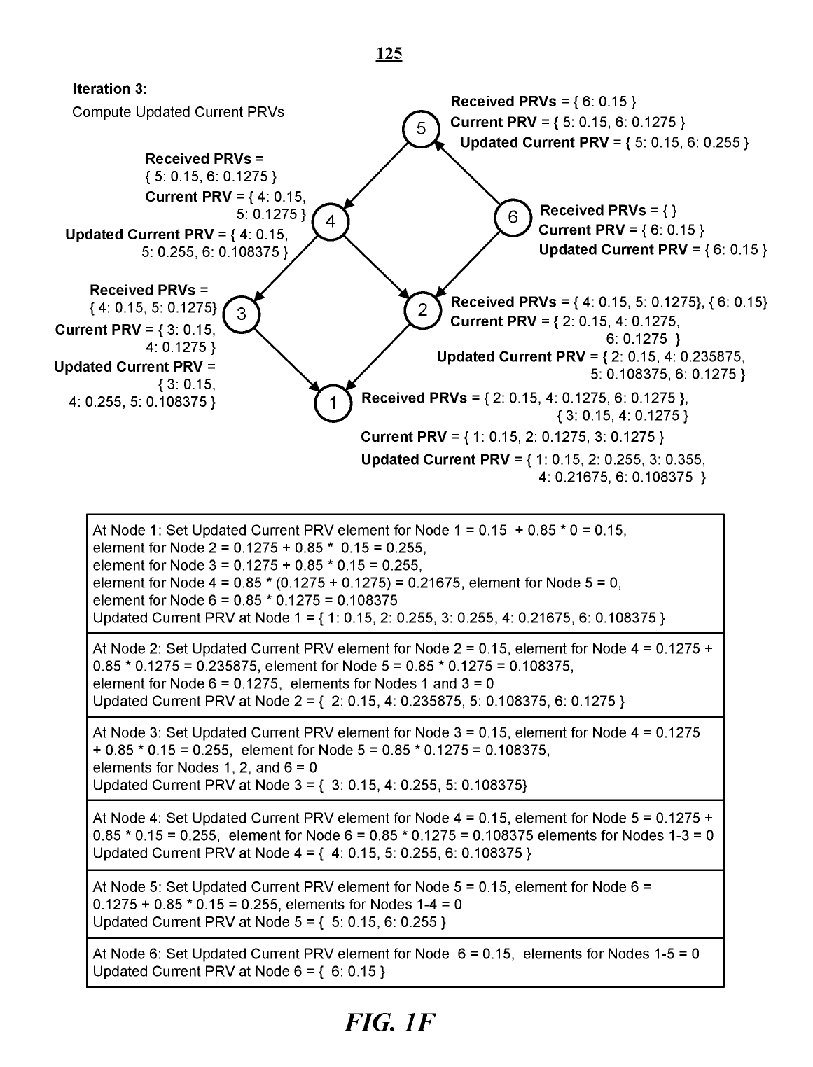

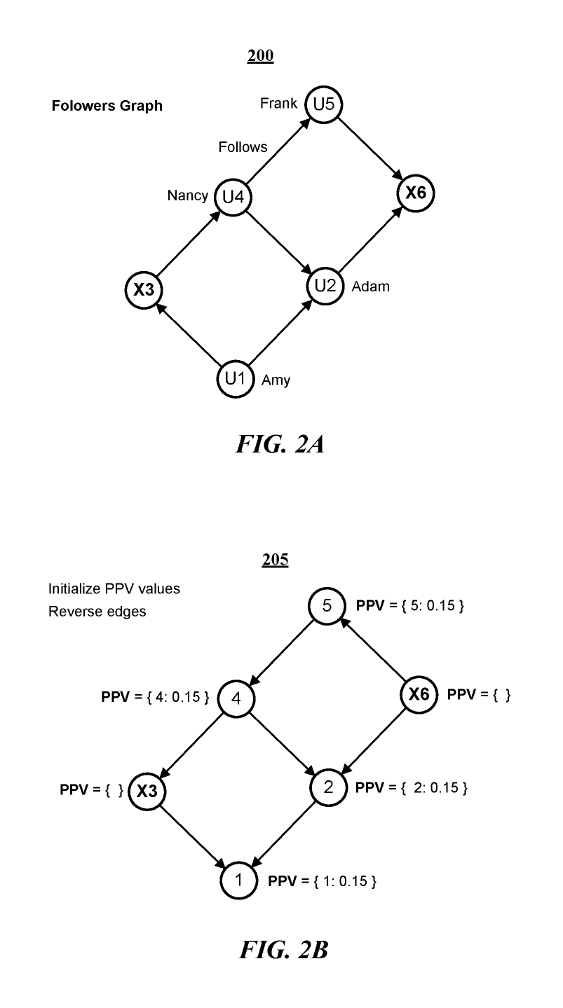

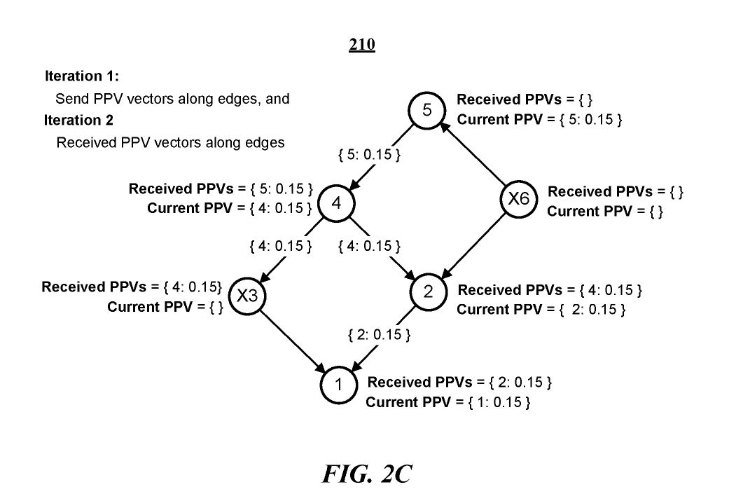

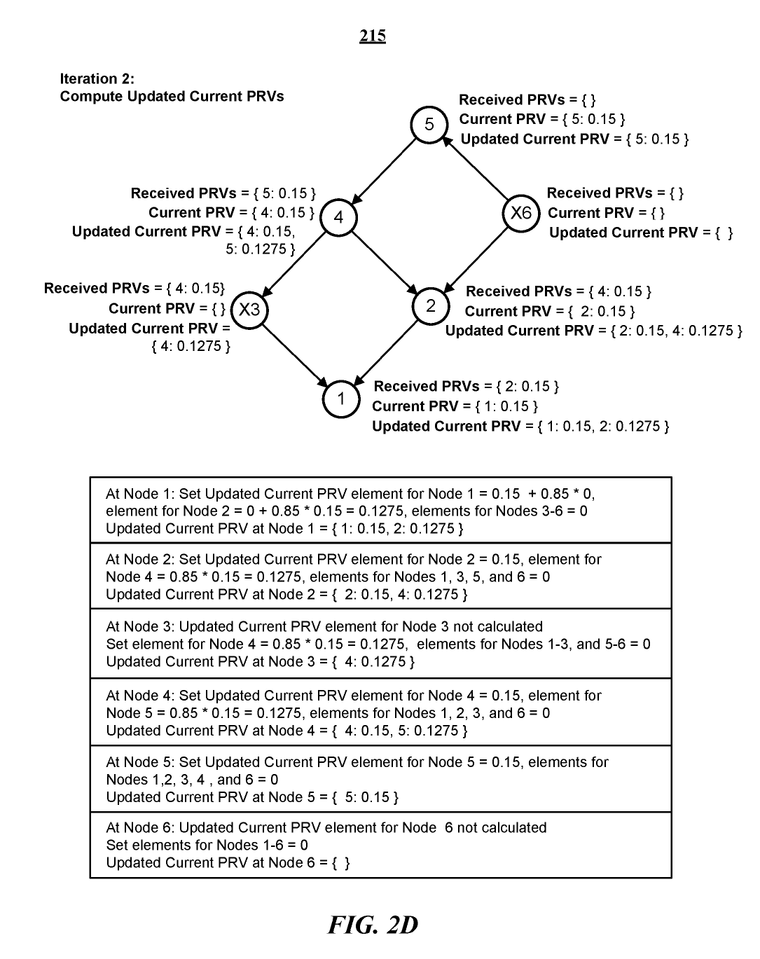

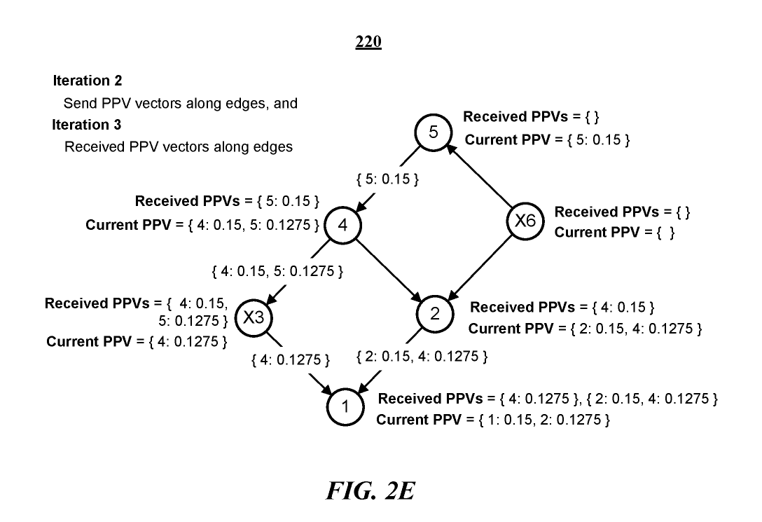

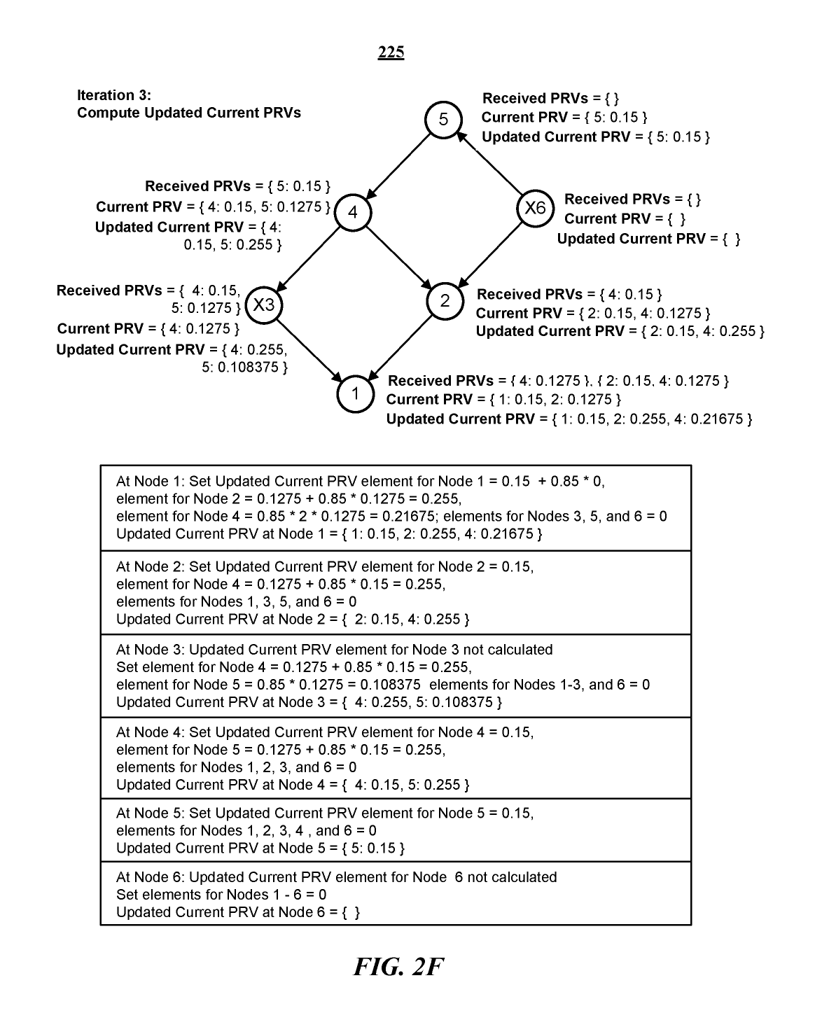

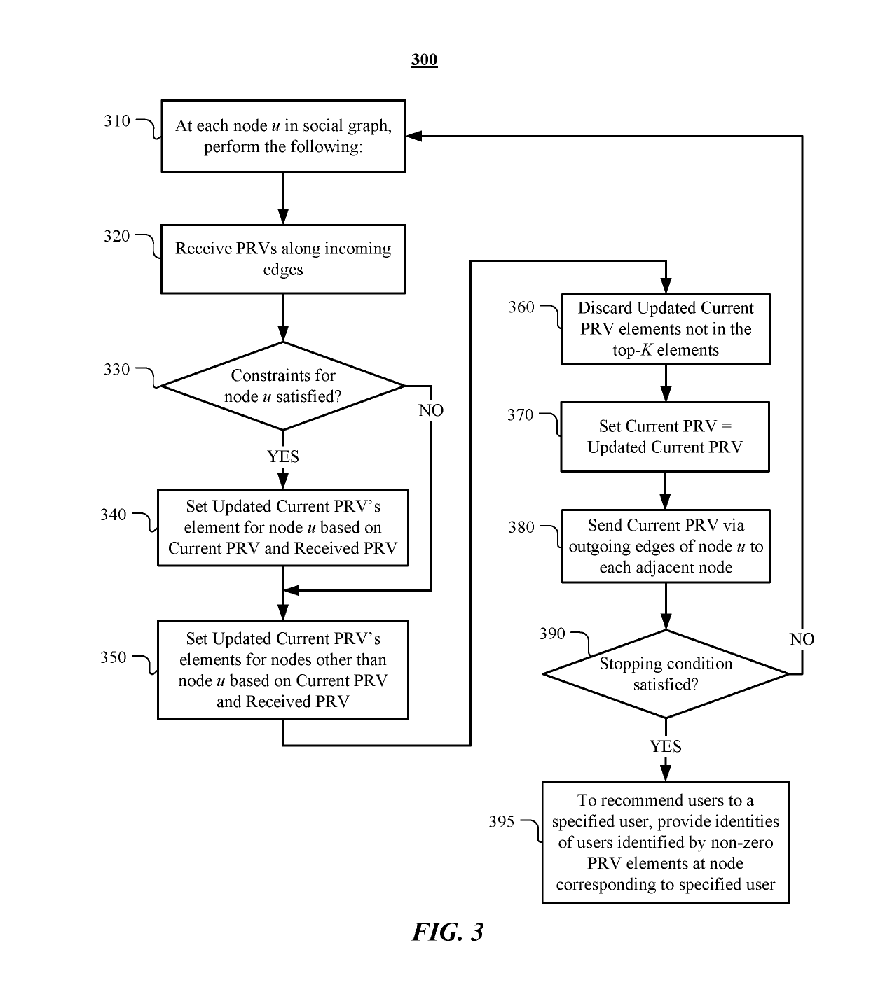

FIGS. 1A-1F illustrate execution of an example method 300 for selecting candidate users for recommendation. The method 300, which is shown in the flowchart of FIG. 3, may calculate Personalized Rank vectors (PRV) for users in an example social graph 100. The PRV vector elements represent the relative importance of the users to each other in the social graph, and may be used to identify users to recommend to particular user. For example, for a particular user, the relative importance of the other users may be represented by the values of the PRV elements calculated for the other users at the node that corresponds to the particular user. The PRV values may be calculated for each node in an iterative computation such as that shown in the flowchart of FIG. 3. At each iteration of the computation, updated PRV values may be sent to adjacent nodes. The computation of PRVs for the examples of FIGS. 1B-1F proceeds according to the method of FIG. 3, with the constraints being satisfied at step 330 in FIGS. 1B-1F. Further, the value of the discard threshold K at step 360 may be greater than the number of elements in the PRV vectors in the examples of FIGS. 1B-1F unless otherwise indicated. In contrast, the computation of PRVs in the examples of FIGS. 2B-2F proceeds according to the method of FIG. 3, using the same initial graph in FIG. 2B as in FIG. 1B, except the constraints for nodes 3 and 6 are not satisfied at step 330 in the examples of FIGS. 2B-2F, so PRV values are not computed for nodes 3 and 6 in FIGS. 2B-2F.

FIG. 1A illustrates an example social graph 100 that includes nodes representing six example users. Table 1 below lists information about the example users. The information listed in Table 1 may be stored in the social graph, for example. The name, date of account creation, and number of followers associated with each user may be stored as data attributes of the social graph node that corresponds to the user, along with other user information not listed in Table 1.

TABLE 1

| | | Account Created | |
|---|---|---|---|
| User # | Name | (months ago) | # of Followers |
| 1 | Amy | 41 | 26 |
| 2 | Adam | 1 | 18 |
| 3 | Mitt | 9 | 87 |
| 4 | Nancy | 2 | 124 |
| 5 | Frank | 5 | 162411 |
| 6 | Taylor | 7 | 59 million |

The social graph 100 also includes edges between the nodes to represent relationships between the users, and may be a sub-graph of a larger social graph. Each edge in a social graph may represent a follower relationship, a friend relationship, or other type of relationship. A user who follows another user in a social-networking system may receive information about the other user. In the graph 100, each edge represents a follower relationship in which a directed edge from a first node to a second node indicates that a first user represented by the first node follows a second user represented by the second node. In the graph 100, U1 (“Amy”) has edges to U2 (“Adam”) and U3 (“Mitt”), which indicate that U1 follows U2 and U3. U2 (“Adam”) has an edge to U6 (“Taylor”), indicating that U2 follows U6. U3 (“Mitt”) has an edge to U4 (“Nancy”), indicating that U3 follows U4. U4 has an edge to U5 (“Frank”) indicating that U4 follows U5. U5 (“Frank”) has an edge to U6 (“Taylor”) indicating that U5 follows U6. Although the graph 100 has directed edges, other graphs may include undirected edges, e.g., a graph that represents a friend relationship.

FIG. 1B illustrates a social graph 105 after being initialized by an initialization portion of a candidate selection method. Initialization may include initializing PRV vectors to initial values and reversing graph edges. In the example of FIG. 1B, the PRV vectors associated with the nodes of the graph 105 may be set to the illustrated initial values by step 340 of the method 300 of FIG. 3 for each node. In the example graph 105, the PRV vector of each of the four non-excluded user nodes u (Nodes 1, 2, 3, 4, 5, and 6) is initialized to {u: 0.15}, where 0.15 is the teleport probability c. The initial value may be calculated by step 340 using the PRV formula with no node values, in which case the second term of the PRV formula may be zero. The initial value of PRV(u) at each node u may thus be set to the first term of the PRV formula, which is c, since there are no previous or current values to include in the PRV calculation. The second term of the PRV formula may be zero in the first iteration of the method 300 because the sum of values received from other nodes is initially zero. At node 1, the vector PRV={1: 0.15}, which indicates that the PRV vector stored at node 1 contains an entry for node 1 having the value 0.15. Similarly, for nodes 2-5, the PRV={u: 0.15} for each node u.

In particular embodiments, the edges of the social graph 105 may be reversed by reversing the direction of each edge in the graph 105. The edges of the graph 105 shown in FIG. 1B have been reversed. For example, in the graph 100 shown in FIG. 1A, the edge directed from node 1 (“Amy”) to node 2 (“Adam”) indicates that the user associated with node 1 (“Amy”) follows the user associated with node 2 (“Adam”). This edge has been reversed to form a corresponding edge from node 1 to node 2 in the graph 105 to indicate that the user associated with node 2 is important to the user associated with node 1, which may be understood as a result of the node 1 user being a follower of the node 2 user in the graph 100.

FIG. 1C illustrates a social graph 110 in which PRV vectors sent via edges between adjacent nodes have been received at the destination nodes. The sending of PRV vectors shown in FIG. 1C may be performed at step 380 in a first iteration of the method 300 of FIG. 3. Note that step 320, which may receive previously-sent vectors, and steps 340-370, which may calculate updated PRV values, are bypassed in the first iteration in this example because no values have been sent prior to step 320 being executed in the first iteration. Thus, there are no received PRV values to use for updating the current PRVs in the first iteration. The receiving of PRV vectors shown in FIG. 1C may be performed at step 320 in a second iteration of the method 300.

In particular embodiments, as described with reference to FIG. 3, three PRV vectors may be maintained at each node u and used for computing updated PRV values: “Received PRVs,” “Current PRV,” and “Updated Current PRV.” These three vectors are described herein for explanatory purposes, and other data representations may be used instead. The Received PRVs vector at node u may include one or more vectors received from other nodes. The Current PRV vector at node u may be the most-recently calculated PRV for node u. The Updated Current PRV vector at node u may be calculated based on the Current PRV and the Received PRV, e.g., according to the PRV formula. The Received PRVs and Current PRV vectors are shown in FIG. 1C. The Updated Current PRV vectors are not shown in FIG. 1C but are shown in FIG. 1D, which illustrates their calculation based on the Received PRVs and Current PRV vectors of FIG. 1C.

In particular embodiments, each node u in the example graph 110 initially has a Current PRV={u: 0.15}. The initial PRV vectors determined in FIG. 1B are shown as the Current PRV vectors in FIG. 1C. FIG. 1C also shows that the Current PRV at each node of the example graph 115 may be sent to adjacent nodes (at step 380) in a first iteration of the method 300. For each pair of adjacent nodes (u, v), the Current PRV vectors may be sent along an edge from node u to node v by step 380 in the first iteration. The vectors sent along the edges may be received at each destination node v at step 320 of the next iteration, which is the second iteration, as shown FIG. 1C.

In particular embodiments, the PRV vectors received at step 320 may be stored in the Received PRVs vector at node v in the second iteration. Each vector received from a node u has the value {u: 0.15} in FIG. 1C. The corresponding Received PRVs, each having the value {u: 0.15}, are shown at each node u in FIG. 1C. A node may receive a separate PRV vector along each incoming edge, so the Received PRVs may contain multiple PRV vectors, e.g., as shown at node 1.

In FIG. 1C, node 1 has received two PRVs: {3: 0.15} and {2: 0.15} from nodes 3 and 2, respectively. The Received PRVs at node 1 is accordingly {3: 0.15},{2: 0.15}. Node 2 has received { 4:0.15} from node 4 and { 6: 0.15} from node 6. The Received PRVs at node 2 are accordingly {4:0.15}, {6: 0.15}. Node 3 has received {4: 0.15} from node 4. The Received PRVs at node 3 is accordingly {4:0.15}. Node 4 has received {5: 0.15} from Node 5. The Received PRVs at node 4 is accordingly {5:0.15}. Node 5 has received {6: 0.15} from Node 6. The Received PRVs at node 5 is accordingly {6:0.15 }. Node 6 has not received any PRVs, so the Received PRVs at node 6 is empty.

Note that although the terms “send” and “receive” are used to describe the communication of vectors between nodes of social graphs, the sending and receiving are not necessarily via a communication network. The sending and receiving may occur within a memory of a computer system or using any other appropriate form of communication. Communication between some of the nodes may be via a communication network, e.g., a wireless or wired network, and communication between other nodes may occur within a computer memory.

FIG. 1D illustrates computation of updated PRV values on a social graph 120 in a second iteration. The computations of Updated Current PRV vectors shown in FIG. 1D may be performed by step 340 at each node u, for element u, since constraints are satisfied for each node u in the example of FIG. 1D and step 350 at each node u, for elements other than element u of FIG. 3. At each node u, the Updated Current PRV vector is set to Current PRV+0.15*Received PRV. This calculation may be performed by step 340 for element u of the vectors (when constraints for node u are satisfied), and by step 350 for elements other than element u. The PRV values at each of the nodes may be calculated as shown in Table 2 below.

TABLE 2

| At | | |
|---|---|---|
| Node | Computation | Updated Current PRV |
| 1 | Set Updated Current PRV element for Node 1 = 0.15 + 0.85 * 0, | {1: 0.15, 2: 0.1275, |
| | element for Node 2 = 0 + 0.85 * 0.15 = 0.1275, element for Node | 3: 0.1275} |
| | 3 = 0 + 0.85 * 0.15 = 0.1275, elements for Nodes 4-6 = 0 | |
| 2 | Set Updated Current PRV element for Node 2 = 0.15, element for | {2: 0.15, 4: .1275, |
| | Node 4 = 0.85 * 0.15 = 0.1275, element for Node 6 = 0.85 * 0.15 = 0.1275, | 6: 0.1275} |
| | elements for Nodes 1, 3, and 5 = 0 | |
| 3 | Set Updated Current PRV element for Node 3 = 0.15, element for | {3: 0.15, 4: .1275} |
| | Node 4 = 0.85 * 0.15 = 0.1275, elements for Nodes 1, 2, 5, and 6 = 0 | |
| 4 | Set Updated Current PRV element for Node 4 = 0.15, element for | {4: 0.15, 5: 0.1275} |
| | Node 5 = 0.85 * 0.15 = 0.1275, elements for Nodes 1, 2, 3, and 6 = 0 | |
| 5 | Set Updated Current PRV element for Node 5 = 0.15, element for | {5: 0.15, 6: 0.1275} |
| | Node 6 = 0.85 * 0.15 = 0.1275, elements for Nodes 1, 2, 3, and 4 = 0, | |
| 6 | Set Updated Current PRV element for Node 6 = 0.15, elements | {6: 0.15} |
| | for Nodes 1, 2, 3, 4, and 5 = 0, | |

In particular embodiments, step 360 does not discard any PRV elements in the example of FIGS. 1A-1F, as described above. Step 370 may set Current PRV=Updated Current PRV, so Updated Current PRV becomes the new Current PRV.

The PRV values calculated in FIG. 1D may indicate the relative importance of the users as determined in the second iteration of the method 300. The relative importance of other users to a particular user may be identified from the PRV values at the particular user's node, though the values at a particular node are not necessarily the final values until a sufficient number of iterations have been executed. For example, the values may be considered final when they are no longer changing in each iteration, or are changing by less than a threshold amount in each iteration. For example, at node 1, the PRV values of nodes 2 and 3, which are both 0.1275, are equal. Thus, the users corresponding to nodes 2 and 3 are of equal relative importance to the user corresponding to node 1 after iteration 2 in this example. When determining the relative importance of other users to a particular user, the particular user's node value is ordinarily not considered.

FIG. 1E illustrates a social graph 120 in which PRV values sent via edges between adjacent nodes have been received at the destination nodes. The sending of PRV vectors shown in FIG. 1E may be performed at step 380 in a second iteration of the method 300 of FIG. 3. The receiving of PRV vectors shown in FIG. 1E may be performed at step 320 in a third iteration of the method 300. The Updated Current PRV vectors calculated in FIG. 1D are shown as the Current PRV vectors in FIG. 1E. PRV values are sent from source nodes to destination nodes in FIG. 1E as specified in Table 3 below.

TABLE 3

| Source | | Destination |
|---|---|---|
| Node | Values | Node(s) |
| 1 | None | None |
| 2 | {2: 0.15, 4: 0.1275, 6: 0.1275} | 1 |
| 3 | {3: 0.15, 4: 0.1275} | 1 |
| 4 | {4: 0.15, 5: 0.1275} | 2, 3 |
| 5 | {5: 0.15, 6: 0.1275} | 4 |
| 6 | {6: 0.15} | 2, 5 |

FIG. 1F illustrates computation of new PRV values on a social graph 135 in a third iteration. The computations of Updated Current PRV vectors shown in FIG. 1F may be performed by step 340 at each node u, for element u, since constraints are satisfied for each node u in the example of FIG. 1F and step 350 at each node u, for elements other than element u of FIG. 3. At each node u, Updated Current PRV is set to Current PRV+0.15*Received PRV. This calculation may be performed by step 340 for element u of the vectors (when constraints for node u are satisfied), and by step 350 for elements other than element u. The PRV vectors at each of the nodes may be calculated as shown in Table 4 below.

TABLE 4

| At | | |
|---|---|---|
| Node | Computation | Updated Current PRV |
| 1 | Set Updated Current PRV element for Node 1 = 0.15 + 0.85 * 0 = | {1: 0.15, 2: 0.255, |
| | 0.15, element for Node 2 = 0.1275 + 0.85 * 0.15 = | 3: 0.255, 4: 0.21675, |
| | 0.255, element for Node 3 = 0.1275 + 0.85 * 0.15 = 0.255, | 6: 0.108375} |
| | element for Node 4 = 0.85 * (0.1275 + 0.1275) = 0.21675, | |
| | element for Node 5 = 0, element for Node 6 = 0.85 * 0.1275 = | |
| | 0.108375 | |
| 2 | Set Updated Current PRV element for Node 2 = 0.15, element | {2: 0.15, 4: 0.235875, |
| | for Node 4 = 0.1275 + 0.85 * 0.1275 = 0.235875, element for | 5: 0.108375, 6: 0.1275} |
| | Node 5 = 0.85 * 0.1275 = 0.108375, element for Node 6 = | |
| | 0.1275, elements for Nodes 1 and 3 = 0 | |
| 3 | Set Updated Current PRV element for Node 3 = 0.15, element | {3: 0.15, 4: 0.255, |
| | for Node 4 = 0.1275 + 0.85 * 0.15 = 0.255, element for Node | 5: 0.108375} |
| | 5 = 0.85 * 0.1275 = 0.108375, elements for Nodes 1, 2, and 6 = 0 | |
| 4 | Set Updated Current PRV element for Node 4 = 0.15, element | {4: 0.15, 5: 0.255, |
| | for Node 5 = 0.1275 + 0.85 * 0.15 = 0.255, element for Node | 6: 0.108375} |
| | 6 = 0.85 * 0.1275 = 0.108375, elements for Nodes 1-3 = 0 | |
| 5 | Set Updated Current PRV element for Node 5 = 0.15, element | {5: 0.15, 6: 0.255} |
| | for Node 6 = 0.1275 + 0.85 * 0.15 = 0.255 | |
| | elements for Nodes 1-4 = 0 | |
| 6 | Set Updated Current PRV element for Node 6 = 0.15, | {6: 0.15} |
| | elements for Nodes 1-5 = 0 | |

In one example, step 360 does not discard any PRV elements in the example of FIGS. 1A-1F, as described above. In another example, step 360 may discard elements PRV elements that are not in the top-K elements of the PRV. For example, if K=3, then at node 2, the PRV {2: 0.15, 4: 0.235875, 5: 0.108375, 6: 0.1275} may be reduced to {2: 0.15, 4: 0.235875, 5: 0.108375, 6: 0.1275} by discarding elements less than the top 3 elements. In this example, the element 5: 0.108375 may be discarded, resulting in the PRV {2: 0.15, 4: 0.235875, 5: 0.108375, 6: 0.1275}. Step 370 may set Current PRV=Updated Current PRV, so Updated Current PRV becomes the new Current PRV.

FIGS. 2A-2F illustrate execution of an example method for selecting candidate users for recommendation to a particular user using constraints. In particular embodiments, to reduce the amount of computation and also to avoid recommending users that are not considered good candidates for recommendation, constraints may be used to exclude graph nodes from the computation. The reduction in computation resulting from excluding two of six user nodes in a particular example may be seen by comparing FIGS. 2B-2F to FIGS. 1B-1F.

In particular embodiments, one or more constraints may be associated with each node or edge in a social graph 200. If the constraint associated with a node is not satisfied, e.g., evaluates to false, then the node(s) associated with the constraint may be excluded from the computations. Using constraints enables exclusion of users who are unlikely to be recommended, thus increasing the accuracy of the recommendations and reducing the amount of computational resources used in generating the recommendations.

In particular embodiments, each constraint may correspond to or include a logical condition based on one or more variables. The condition may be evaluated, using values associated with the variables, to produce a Boolean (true or false) result. For example, a condition may be “number of followers<=25” to indicate that a user is only to be evaluated for recommendation if the user has 25 or fewer followers. The variable in that condition is “number of followers” and the value of the variable, e.g., the number of followers, may be determined from a user node associated with the constraint. Thus, the variables may be attributes of users, such as the number of followers a user has, the date on which the user joined the social network (e.g., account creation date), the date on which the user was most recently active on the social network, the user's current location, demographic information (age, gender, occupation, and so on), interests (e.g., recent activities, hobbies), friends, followers, group memberships, events registered for, events attended, events managed, check-ins (e.g., locations, places), posts and/or comments, number of posts and/or comments, and the like. A constraint may be associated with a particular node (or edge), in which case the constraint may apply only to that node (or edge). Alternatively, a constraint may apply to all or a subset of all nodes (or edges) in the social graph.

In particular embodiments, one or more of the constraints may be evaluated in each iteration of the method 300 shown in FIG. 3, and any nodes for which the constraints are false may be excluded from computations performed by the method 300. Evaluating constraints for each iteration may be useful when the constraints include variables whose values may change during the computation, e.g., a user's location. Alternatively, one or more of the constraints may be evaluated once, e.g., in an initialization step such as step 310 of the method 300 shown in FIG. 3, and computations for each node for which at least one constraint is false may be excluded from each iteration of the computation, at least until the constraint is re-evaluated. A constraint may be re-evaluated, for example, when one or more of the constraint's variables may have changed. As an example, a constraint based on the number of followers a user has may be re-evaluated when the user gains or loses a follower. When a constraint is re-evaluated, the method 300 for selecting candidate users may be performed again. As another example, the method 300 may be performed again if re-evaluation of the constraint changes the result of the constraint, so that the node either becomes included or excluded. As still another example, the method 300 may be performed again if re-evaluation of the constraint changes the result of the constraint so that the node becomes included, but not if the node becomes excluded, since a new recommended user may be of interest to other users, but removing a previously-recommended user is not ordinarily of interest to users. However, there is a possibility that removing a previously-recommended user will open space for another user to be added to the recommendation list, so performing the method 300 to identify recommended users when the constraint changes so that a node becomes excluded may produce useful results.

FIG. 2A illustrates an example social graph 200 that includes four nodes 1, 2, 4, and 5 that are included in candidate selection computation and two nodes 3 and 6 that are excluded. Nodes 3 and 6 are therefore referred to respectively as Nodes X3 and X6 in this description to emphasize that they are excluded. In particular embodiments, when a node is excluded from a computation, the PRV value for the node is not computed. Consequently, PRV values for an excluded nodes need not be sent between nodes. The excluded node may remain in the graph, however, and may receive PRV values from adjacent nodes and forward the PRV values to other adjacent nodes. Node X6 (“Taylor”) from FIG. 1A has been excluded because, in this example, the corresponding user “Taylor” failed a constraint on the maximum number of followers. For example, the constraint associated with Node X6 (and the other nodes of FIG. 2A) may be “number of followers<500.” Since the user “Taylor” has 59 million followers (as shown in Table 1), this constraint is not satisfied, and the corresponding Node X6 is excluded from the computation in the examples of FIGS. 2A-2F.

Further, Node X3 (“Mitt”) has also been excluded in the examples of FIGS. 2A-2F, because the corresponding user “Mitt” failed a constraint on the maximum account age. For example, the constraint associated with Node X3 (and the other nodes of FIG. 2A) may be “account age<8 years.” Since the user account for “Mitt”) was created 9 years ago (according to Table 1), the constraint is not satisfied, and Node X3 is excluded from the example computation.

FIG. 2B illustrates a social graph 205 after being initialized by an initialization portion of a candidate selection method. In the example of FIG. 2B, the PRV vectors associated with the nodes of the graph 205 may be set to the illustrated initial values by step 340 of the method 300 of FIG. 3 for each node for which associated constraints (if any) are satisfied when they are evaluated at step 330. In the example graph 205, the PRV vector of each of the four non-excluded user nodes u (Nodes 1, 2, 4, and 5) is initialized to {u: 0.15}, where 0.15 is the teleport probability c. The PRV values associated with the two excluded nodes (Nodes X3 and X6) are not initialized, and are shown as empty. Alternatively, the PRV values associated with the excluded nodes may be set to a predetermined value to indicate they are invalid, e.g., to 0, −1, or other appropriate value. Values for nodes X3 and X6 at nodes X3 and X6 are not set because step 340 of the method 300, which may set Updated Current PRVs at node u for node u, is bypassed for those nodes as a result of the constraints not being satisfied for those nodes. Alternatively, the method 300 may include a step (not shown) that sets the values of nodes for which constraints are not satisfied to a predetermined value to indicate that they are invalid, as described above. The PRV vectors of the excluded nodes may, however, store values received from non-excluded nodes, e.g., vector elements for nodes other than the excluded nodes, for forwarding to other nodes.

FIG. 2C illustrates a social graph 210 on which PRV values are sent via edges between adjacent nodes in a first iteration. The example shown in FIG. 2C is similar to that of FIG. 1C, but the nodes X3 and X6 are excluded in FIG. 2C, as described above with reference to FIG. 2A. The sending of PRV vectors shown in FIG. 2C may be performed at step 380 in a first iteration of the method 300 of FIG. 3. Since nodes X3 and X6 are excluded, there are no values at those nodes for those nodes, as described above with reference to FIG. 2B. Thus, no PRV vector elements for those nodes are sent via the edges from those nodes to adjacent nodes in FIG. 2C. PRV vectors are sent from nodes 1, 2, 4, and 5 via edges to adjacent nodes, and have been received at the adjacent nodes. Note that step 320, which may receive previously-sent vectors, and steps 340-370, which may calculate updated PRV values, are bypassed in the first iteration in this example because no values have been sent prior to step 320 being executed in the first iteration. Thus, there are no received PRV values to use for updating the current PRVs at steps 340-370 of the first iteration. The receiving of PRV vectors shown in FIG. 2C may be performed at step 320 in a second iteration of the method 300.

Because two nodes have been excluded, there is less communication and thus less resource usage in FIG. 2C as compared to FIG. 1C, in which no nodes are excluded. Each of the four user nodes in FIG. 2C initially has the value 0.15, and the PRV elements for each of the four user nodes having valid values are propagated to other nodes in each iteration of the method 300. There are no valid PRV values for node 3 at node 3 and for node 6 at node 6, so, in the example of FIG. 2C, those PRV elements are not sent from nodes 3 and 6. PRVs are sent from source nodes to destination nodes in FIG. 2C as specified in Table 5 below.

TABLE 5

| Source | | Destination |
|---|---|---|
| Node | PRV | Node(s) |
| 1 | None | None |
| 2 | {2: 0.15} | 1 |
| 3 | None | None |
| 4 | {4: 0.15} | 2, 3 |
| 5 | {5: 0.15} | 4 |
| 6 | None | None |

FIG. 2D illustrates computation of updated PRV values on a social graph 220 in a second iteration. The computations of Updated Current PRV vectors shown in FIG. 2D may be performed by step 340 for nodes 1, 2, 4, and 5, since constraints for those nodes are satisfied for the purposes of the example of FIG. 2D, and by step 350 at each node u, for elements other than element u. At each node u, the Updated Current PRV vector may be set to Current PRV+0.15* Received PRV. This calculation may be performed by step 340 for element u of the vectors when constraints for node u are satisfied, and by step 350 for elements other than element u.

In the example of FIG. 2D, step 330 determines that the constraints for nodes X3 and X6 are not satisfied, and causes step 340 to be bypassed for those two nodes. As a result, there is no element (or there may be a predetermined element value such as 0) in the PRV vector at Node X3 for Node X3 and in the PRV vector at Node X6 for Node X6. Thus, at Nodes X3 and X6, no PRV vector elements are available for use in computing updated PRV elements for those nodes. In particular embodiments, PRV elements that do not exist or are otherwise invalid (e.g., have a predetermined value such as 0) are not used in PRV calculations, and are not ordinarily sent to other nodes, thus reducing the computational and communication resource usage of the candidate selection method 300.

The PRV values at each of the nodes in FIG. 2D may be calculated as shown in Table 6 below.

TABLE 6

| At | | |
|---|---|---|
| Node | Computation | Updated Current PRV |
| 1 | Set Updated Current PRV element for Node 1 = 0.15 + 0.85 * 0, | {1: 0.15, 2: 0.1275} |
| | element for Node 2 = 0 + 0.85 * 0.15 = 0.1275, elements for | |
| | Nodes 3-6 = 0 | |
| 2 | Set Updated Current PRV element for Node 2 = 0.15, element | {2: 0.15, 4: 0.1275} |
| | for Node 4 = 0.85 * 0.15 = 0.1275, elements for Nodes 1, 3, 5, | |
| | and 6 = 0 | |
| 3 | Updated Current PRV element for Node 3 not calculated | {4: 0.1275} |
| | Set element for Node 4 = 0.85 * 0.15 = 0.1275, elements for | |
| | Nodes 1-3, and 5-6 = 0 | |
| 4 | Set Updated Current PRV element for Node 4 = 0.15, element | {4: 0.15, 5: 0.1275} |
| | for Node 5 = 0.85 * 0.15 = 0.1275, elements for Nodes 1, 2, 3, | |
| | and 6 = 0 | |
| 5 | Set Updated Current PRV element for Node 5 = 0.15, | {5: 0.15} |
| | elements for Nodes 1, 2, 3, 4 , and 6 = 0 | |
| 6 | Updated Current PRV element for Node 6 not calculated | { } |
| | Set elements for Nodes 1-6 = 0 | |

In particular embodiments, step 360 may discard any PRV elements that are not in the top-K elements of the PRV. For example, if K=2, and a PRV has the elements {1: 0.15, 2: 0.1275, 3: 0.415, 4: 0.2}, then the top elements may be retained and elements not in the top 2 may be discarded. The resulting PRV in this example for K=2 may be {3: 0.415, 4: 0.2}. The elements 1: 0.15 and 2: 0.1275 are discarded because their values are less than the top 2 values in the PRV.

In particular embodiments, step 370 may then set Current PRV=Updated Current PRV, so Updated Current PRV becomes the new Current PRV. Step 370 may alternatively be understood as discarding Current PRV and renaming Updated Current PRV to Current PRV.

FIG. 2E illustrates a social graph 120 in which PRV values sent via edges between adjacent nodes are received at the destination nodes. The sending of PRV vectors shown in FIG. 2E may be performed at step 380 in a second iteration of the method 300 of FIG. 3. The receiving of PRV vectors shown in FIG. 2E may be performed at step 320 in a third iteration of the method 300. The Updated Current PRV vectors calculated in FIG. 2D are shown as the Current PRV vectors in FIG. 2E. PRV values are sent from source nodes to destination nodes in FIG. 2E as specified in Table 7 below. As a result of nodes X3 and X6 being excluded for failing to satisfy constraints, the vector sent from node X3 to node 4 has been reduced in size to one element {4: 0.1275} from two elements {3: 0.15, 4: 0.1275}, and the vector sent from node X6 to nodes 2 and 5 has been reduced from one element {6: 0.15} to no elements { }, as can be seen by comparing Table 7 to Table 3.

TABLE 7

| Source | | Destination |
|---|---|---|
| Node | Values | Node(s) |
| 1 | None | None |
| 2 | {2: 0.15, 4: 0.1275} | 1 |
| X3 | {4: 0.1275} | 1 |
| 4 | {4: 0.15, 5: 0.1275} | 2, 3 |
| 5 | {5: 0.15} | 4 |
| X6 | { } | None |

FIG. 2F illustrates computation of new PRV values on a social graph 135 in a third iteration, as may be performed when the stopping condition evaluated at step 390 is not satisfied. The computation of Updated Current PRV vectors shown in FIG. 2F may be performed similarly to the computation described above with reference to FIG. 2C. The PRV vectors at each of the nodes may be calculated as shown in Table 8 below.

TABLE 8

| At | | |
|---|---|---|
| Node | Computation | Updated Current PRV |
| 1 | Set Updated Current PRV element for Node 1 = 0.15 + 0.85 * 0, | {1: 0.15, 2: 0.255, |
| | element for Node 2 = 0.1275 + 0.85 * 0.1275 = 0.255, | 4: 0.21675} |
| | element for Node 4 = 0.85 * 2 * 0.1275 = 0.21675; elements for | |
| | Nodes 3, 5, and 6 = 0 | |
| 2 | Set Updated Current PRV element for Node 2 = 0.15, element for | {2: 0.15, 4: 0.255} |
| | Node 4 = 0.1275 + 0.85 * 0.15 = 0.255, elements for Nodes 1, 3, | |
| | 5, and 6 = 0 | |
| 3 | Updated Current PRV element for Node 3 not calculated. Set | {4: 0.255, 5: 0.108375} |
| | element for Node 4 = 0.1275 + 0.85 * 0.15 = 0.255, element for | |
| | Node 5 = 0.85 * 0.1275 = 0.108375 elements for Nodes 1-3, and | |
| | 6 = 0 | |
| 4 | Set Updated Current PRV element for Node 4 = 0.15, element for | {4: 0.15, 5: 0.255} |
| | Node 5 = 0.1275 + 0.85 * 0.15 = 0.255, elements for Nodes 1, 2, | |
| | 3, and 6 = 0 | |
| 5 | Set Updated Current PRV element for Node 5 = 0.15, elements | {5: 0.15} |
| | for Nodes 1, 2, 3, 4 , and 6 = 0 | |
| 6 | Updated Current PRV element for Node 6 not calculated. | { } |
| | Set elements for Nodes 1-6 = 0 | |

In particular embodiments, step 360 may discard any PRV elements that are not in the top-K elements of the PRV. The method 300 may then update the Current PRV at step 370 and send the Current PRV via outgoing edges at step 380. The method 300 may then evaluate the stopping condition at step 390. Alternatively, the stopping condition may be evaluated prior to sending the Current PRV via outgoing edges, so the Current PRV is not sent if there are no further iterations to receive the Current PRV. If the stopping condition is satisfied, the method 300 may stop iterating and continue to step 395, which may recommend users to a selected user based on the PRV values at the node that corresponds to the selected user. For example, if the selected user is user 1, the PRV at node 1 in Table 8 is {1: 0.15, 2: 0.255, 4: 0.21675}. Accordingly, the users may be ranked in order of greatest to least element values, 0.255, 0.21675, 0.15, to generate the ranked list 2, 4, 1. User 2 is the highest-ranked user in this list and may be the first choice for recommendation to user 1. User 4 is the second-highest-ranked user and may be the second choice for recommendation to user 1. User 1 is third in the list, but is not recommended to user 1 because users are not ordinarily recommended to themselves. Both users 2 and 4 may be recommended to user 1, with user 2 being first and user 4 being second in a list of recommended users presented to user 1.

FIG. 3 illustrates an example method 300 for selecting candidate users for recommendation. The method 300 may begin at step 310 by, at each node u of a social graph, e.g., on a processor p(u) associated with each node u, performing the subsequent steps of the method 300 on the processor p(u) for node u. Each processor may be associated with one or more nodes of the social graph. The same processor may be associated with each node of the graph, in which case p(u) may represent the same processor for each node u. Each execution of step 310 may start a new iteration of the method 300. At step 320, the method may receive personalized rank vectors (PRVs) along incoming edges, if any PRVs have been sent by other nodes. At each node, as shown in FIG. 2D, for example, three PRV vectors may be maintained at each node u and used in computing updated PRV values: Received PRVs, Current PRV, and Updated Current PRV. These three vectors are described herein for explanatory purposes, and other data representations may be used instead, e.g., a Received PRVs vector and a Current PRV vector without an Updated Current PRV vector, or other appropriate data structure. The Received PRVs vector at node u may include one or more vectors received from other nodes. The Current PRV vector at node u may be the most-recently calculated PRV for node u. The Updated Current PRV vector at node u may be calculated based on the Current PRV and the Received PRV. The Updated Current PRV need not be separate from the Current PRV, but is described herein as being separate for explanatory purposes. Step 320 may thus receive PRVs along edges incident on node u and set the Received PRVs at node u to include the PRVs received along the incident edges in the current iteration.

At step 330, the method may determine whether one or more constraints are associated with node u and, if so, determine whether node u satisfies the constraints. If there are no constraints associated with node u, the method may continue to step 340. If one or more constraints are associated with node u, the constraints may be evaluated to determine whether they are satisfied. If there are no constraints associated with the node u, or all of the constraints associated with node u are satisfied, then the method may continue to step 340. If one or more of the constraints associated with node u are not satisfied, then the method may continue to step 350, thus bypassing step 340's calculation of the Updated Current PRV element for node u. evaluating each constraint associated with each node in the graph.

For example, step 330 may determine whether each constraint is satisfied, and mark each node for which at least one constraint is not satisfied, e.g., by setting a Boolean “constraints satisfied” value associated with the node to false. In this way, each constraint may be evaluated once and the result re-used in subsequent iterations, instead of being evaluated at each iteration of the loop that repeats steps 310 through 380. In subsequent iterations, step 330 may determine whether the constraints for node u are satisfied by determining whether node u's associated “constraints satisfied” variable is true. In particular embodiments, the constraints may be re-evaluated when information upon which the constraints depends changes, e.g., when nodes or edges are added to or removed from the social graph.

At step 340, the method may determine the Updated Current PRV element for node u based on the existing Current PRV element for node u, if any, and the element for node u in the Received PRV (received at step 320), if any. For example, based on the PRV formula, step 340 may, at node u, set the element of Updated Current PRV that corresponds to node u, e.g.,

Updated Current PRV(u)=Current PRV(u)+(1−c)*Received PRV(u).

If there is no value for Current PRV(u), then Updated Current PRV(u) may be set to c (e.g., 0.15).

At step 350, in particular embodiments, the method may determine the Current PRV element(s) for node(s) other than node u. For example, based on the PRV formula, step 350 may, at node u, set the elements of Updated Current PRV that correspond to nodes other than u, e.g.,

Updated Current PRV(v)=Current PRV(v)+(1−c)*Received PRV(v), for each element v in Received PRV not equal to u.

In other embodiments, at step 350 the method may set the Updated Current PRV elements for nodes other than u to the corresponding Received PRV elements, without calculating values for the Updated Current PRV elements.

At step 360, the method may, discard current PRV elements that are not in the top-K elements of the PRV. For example, step 360 may retain only the K greatest values in node u's Updated Current PRV vector that are associated with nodes other than node u, where K is a predetermined number, e.g., 5, 10, 15, or the like. The value of K may be specified as a configuration parameter, for example. At step 370, the method may set the Current PRV to the Updated Current PRV at node u. For example, step 370 may replace the Current PRV with the Updated Current PRV. At step 380, the method may send the Current PRV of node u via edges that are directed from node u to each adjacent node.

At step 390, the method may determine whether a stopping condition is satisfied. The stopping condition may be, e.g., that at least a threshold number of iterations of the loop between steps 310 and 380 have been executed, or that the magnitude in change of values of elements of the Current PRV in the current iteration compared to the previous iteration is less than a threshold value (e.g., the computation has converged). At step 395, to recommend users to a particular user u, the method may provide the identities of users corresponding to non-zero elements of Current PRV at node u.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for selecting candidate users for recommendation including the particular steps of the method of FIG. 3, this disclosure contemplates any suitable method for selecting candidate users for recommendation including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

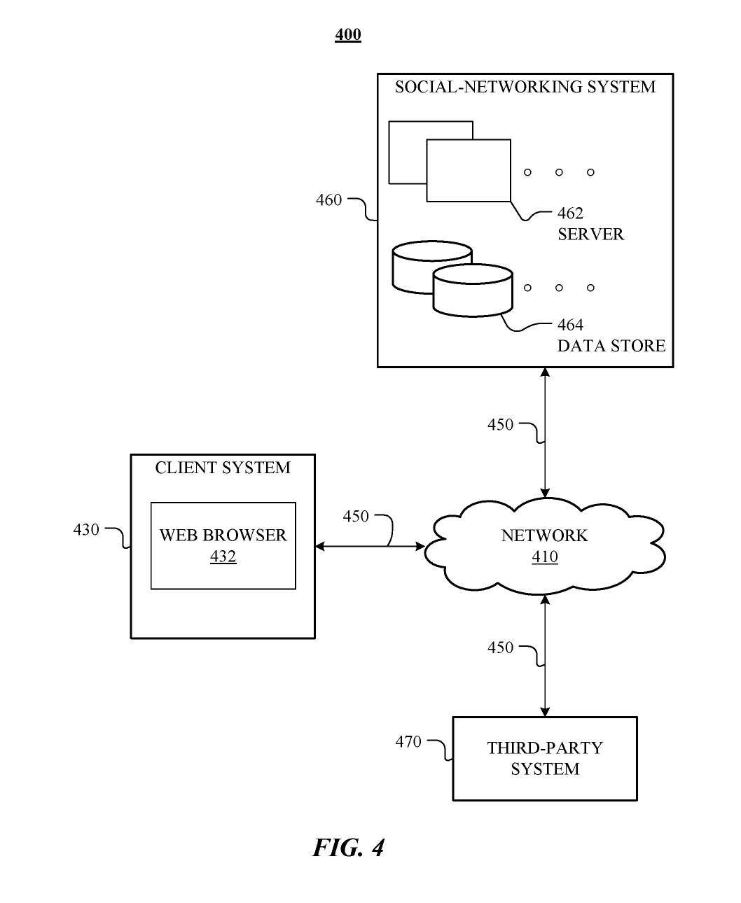

FIG. 4 illustrates an example network environment 400 associated with a social-networking system. Network environment 400 includes a client system 430, a social-networking system 460, and a third-party system 470 connected to each other by a network 410. Although FIG. 4 illustrates a particular arrangement of client system 430, social-networking system 460, third-party system 470, and network 410, this disclosure contemplates any suitable arrangement of client system 430, social-networking system 460, third-party system 470, and network 410. As an example and not by way of limitation, two or more of client system 430, social-networking system 460, and third-party system 470 may be connected to each other directly, bypassing network 410. As another example, two or more of client system 430, social-networking system 460, and third-party system 470 may be physically or logically co-located with each other in whole or in part. Moreover, although FIG. 4 illustrates a particular number of client systems 430, social-networking systems 460, third-party systems 470, and networks 410, this disclosure contemplates any suitable number of client systems 430, social-networking systems 460, third-party systems 470, and networks 410. As an example and not by way of limitation, network environment 400 may include multiple client system 430, social-networking systems 460, third-party systems 470, and networks 410.

This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 410 may include one or more networks 410.

Links 450 may connect client system 430, social-networking system 460, and third-party system 470 to communication network 410 or to each other. This disclosure contemplates any suitable links 450. In particular embodiments, one or more links 450 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 450, or a combination of two or more such links 450. Links 450 need not necessarily be the same throughout network environment 400. One or more first links 450 may differ in one or more respects from one or more second links 450.

In particular embodiments, client system 430 may be an electronic device including hardware, software, or embedded logic components or a combination of two or more such components and capable of carrying out the appropriate functionalities implemented or supported by client system 430. As an example and not by way of limitation, a client system 430 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 430. A client system 430 may enable a network user at client system 430 to access network 410. A client system 430 may enable its user to communicate with other users at other client systems 430.

In particular embodiments, client system 430 may include a web browser 432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 430 may enter a Uniform Resource Locator (URL) or other address directing the web browser 432 to a particular server (such as server 462, or a server associated with a third-party system 470), and the web browser 432 may generate a Hyper Text Transfer Protocol (HTTP) request and communicate the HTTP request to server. The server may accept the HTTP request and communicate to client system 430 one or more Hyper Text Markup Language (HTML) files responsive to the HTTP request. Client system 430 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 460 may be a network-addressable computing system that can host an online social network. Social-networking system 460 may generate, store, receive, and send social-networking data, such as, for example, user-profile data, concept-profile data, social-graph information, or other suitable data related to the online social network. Social-networking system 460 may be accessed by the other components of network environment 400 either directly or via network 410. As an example and not by way of limitation, client system 430 may access social-networking system 460 using a web browser 432, or a native application associated with social-networking system 460 (e.g., a mobile social-networking application, a messaging application, another suitable application, or any combination thereof) either directly or via network 410. In particular embodiments, social-networking system 460 may include one or more servers 462. Each server 462 may be a unitary server or a distributed server spanning multiple computers or multiple datacenters. Servers 462 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 462 may include hardware, software, or embedded logic components or a combination of two or more such components for carrying out the appropriate functionalities implemented or supported by server 462. In particular embodiments, social-networking system 460 may include one or more data stores 464. Data stores 464 may be used to store various types of information. In particular embodiments, the information stored in data stores 464 may be organized according to specific data structures. In particular embodiments, each data store 464 may be a relational, columnar, correlation, or other suitable database. Although this disclosure describes or illustrates particular types of databases, this disclosure contemplates any suitable types of databases. Particular embodiments may provide interfaces that enable a client system 430, a social-networking system 460, or a third-party system 470 to manage, retrieve, modify, add, or delete, the information stored in data store 464.

In particular embodiments, social-networking system 460 may store one or more social graphs in one or more data stores 464. In particular embodiments, a social graph may include multiple nodes—which may include multiple user nodes (each corresponding to a particular user) or multiple concept nodes (each corresponding to a particular concept)—and multiple edges connecting the nodes. Social-networking system 460 may provide users of the online social network the ability to communicate and interact with other users. In particular embodiments, users may join the online social network via social-networking system 460 and then add connections (e.g., relationships) to a number of other users of social-networking system 460 to whom they want to be connected. Herein, the term “friend” may refer to any other user of social-networking system 460 with whom a user has formed a connection, association, or relationship via social-networking system 460.

In particular embodiments, social-networking system 460 may provide users with the ability to take actions on various types of items or objects, supported by social-networking system 460. As an example and not by way of limitation, the items and objects may include groups or social networks to which users of social-networking system 460 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 460 or by an external system of third-party system 470, which is separate from social-networking system 460 and coupled to social-networking system 460 via a network 410.

In particular embodiments, social-networking system 460 may be capable of linking a variety of entities. As an example and not by way of limitation, social-networking system 460 may enable users to interact with each other as well as receive content from third-party systems 470 or other entities, or to allow users to interact with these entities through an application programming interfaces (API) or other communication channels.

In particular embodiments, a third-party system 470 may include one or more types of servers, one or more data stores, one or more interfaces, including but not limited to APIs, one or more web services, one or more content sources, one or more networks, or any other suitable components, e.g., that servers may communicate with. A third-party system 470 may be operated by a different entity from an entity operating social-networking system 460. In particular embodiments, however, social-networking system 460 and third-party systems 470 may operate in conjunction with each other to provide social-networking services to users of social-networking system 460 or third-party systems 470. In this sense, social-networking system 460 may provide a platform, or backbone, which other systems, such as third-party systems 470, may use to provide social-networking services and functionality to users across the Internet.

In particular embodiments, a third-party system 470 may include a third-party content object provider. A third-party content object provider may include one or more sources of content objects, which may be communicated to a client system 430. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 460 also includes user-generated content objects, which may enhance a user's interactions with social-networking system 460. User-generated content may include anything a user can add, upload, send, or “post” to social-networking system 460. As an example and not by way of limitation, a user communicates posts to social-networking system 460 from a client system 430. Posts may include data such as status updates or other textual data, location information, photos, videos, links, music or other similar data or media. Content may also be added to social-networking system 460 by a third-party through a “communication channel,” such as a newsfeed or stream.

In particular embodiments, social-networking system 460 may include a variety of servers, sub-systems, programs, modules, logs, and data stores. In particular embodiments, social-networking system 460 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 460 may also include suitable components such as network interfaces, security mechanisms, load balancers, failover servers, management-and-network-operations consoles, other suitable components, or any suitable combination thereof. In particular embodiments, social-networking system 460 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 460 to one or more client systems 430 or one or more third-party system 470 via network 410. The web server may include a mail server or other messaging functionality for receiving and routing messages between social-networking system 460 and one or more client systems 430. An API-request server may allow a third-party system 470 to access information from social-networking system 460 by calling one or more APIs. An action logger may be used to receive communications from a web server about a user's actions on or off social-networking system 460. In conjunction with the action log, a third-party-content-object log may be maintained of user exposures to third-party-content objects. A notification controller may provide information regarding content objects to a client system 430. Information may be pushed to a client system 430 as notifications, or information may be pulled from client system 430 responsive to a request received from client system 430. Authorization servers may be used to enforce one or more privacy settings of the users of social-networking system 460. A privacy setting of a user determines how particular information associated with a user can be shared. The authorization server may allow users to opt in to or opt out of having their actions logged by social-networking system 460 or shared with other systems (e.g., third-party system 470), such as, for example, by setting appropriate privacy settings. Third-party-content-object stores may be used to store content objects received from third parties, such as a third-party system 470. Location stores may be used for storing location information received from client systems 430 associated with users. Advertisement-pricing modules may combine social information, the current time, location information, or other suitable information to provide relevant advertisements, in the form of notifications, to a user.

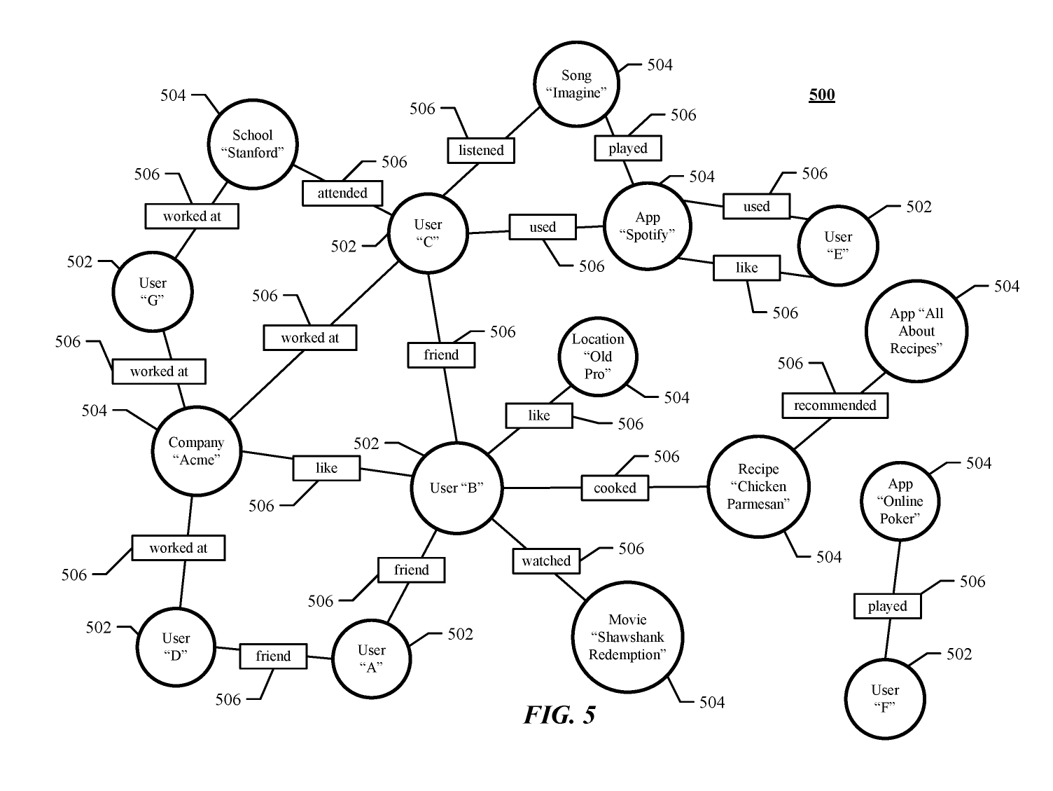

FIG. 5 illustrates example social graph 500. In particular embodiments, social-networking system 460 may store one or more social graphs 500 in one or more data stores. In particular embodiments, social graph 500 may include multiple nodes—which may include multiple user nodes 502 or multiple concept nodes 504—and multiple edges 506 connecting the nodes. Example social graph 500 illustrated in FIG. 5 is shown, for didactic purposes, in a two-dimensional visual map representation. In particular embodiments, a social-networking system 460, client system 430, or third-party system 470 may access social graph 500 and related social-graph information for suitable applications. The nodes and edges of social graph 500 may be stored as data objects, for example, in a data store (such as a social-graph database). Such a data store may include one or more searchable or queryable indexes of nodes or edges of social graph 500.

In particular embodiments, a user node 502 may correspond to a user of social-networking system 460. As an example and not by way of limitation, a user may be an individual (human user), an entity (e.g., an enterprise, business, or third-party application), or a group (e.g., of individuals or entities) that interacts or communicates with or over social-networking system 460. In particular embodiments, when a user registers for an account with social-networking system 460, social-networking system 460 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with social-networking system 460. In particular embodiments, a user node 502 may be associated with information provided by a user or information gathered by various systems, including social-networking system 460. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more webpages.

In particular embodiments, a concept node 504 may correspond to a concept. As an example and not by way of limitation, a concept may correspond to a place (such as, for example, a movie theater, restaurant, landmark, or city); a website (such as, for example, a website associated with social-network system 460 or a third-party website associated with a web-application server); an entity (such as, for example, a person, business, group, sports team, or celebrity); a resource (such as, for example, an audio file, video file, digital photo, text file, structured document, or application) which may be located within social-networking system 460 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 504 may be associated with information of a concept provided by a user or information gathered by various systems, including social-networking system 460. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more webpages.

In particular embodiments, a node in social graph 500 may represent or be represented by a webpage (which may be referred to as a “profile page”). Profile pages may be hosted by or accessible to social-networking system 460. Profile pages may also be hosted on third-party websites associated with a third-party system 470. As an example and not by way of limitation, a profile page corresponding to a particular external webpage may be the particular external webpage and the profile page may correspond to a particular concept node 504. Profile pages may be viewable by all or a selected subset of other users. As an example and not by way of limitation, a user node 502 may have a corresponding user-profile page in which the corresponding user may add content, make declarations, or otherwise express himself or herself. As another example and not by way of limitation, a concept node 504 may have a corresponding concept-profile page in which one or more users may add content, make declarations, or express themselves, particularly in relation to the concept corresponding to concept node 504.

In particular embodiments, a concept node 504 may represent a third-party webpage or resource hosted by a third-party system 470. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 430 to send to social-networking system 460 a message indicating the user's action. In response to the message, social-networking system 460 may create an edge (e.g., a check-in-type edge) between a user node 502 corresponding to the user and a concept node 504 corresponding to the third-party webpage or resource and store edge 506 in one or more data stores.

In particular embodiments, a pair of nodes in social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, social-networking system 460 may send a “friend request” to the second user. If the second user confirms the “friend request,” social-networking system 460 may create an edge 506 connecting the first user's user node 502 to the second user's user node 502 in social graph 500 and store edge 506 as social-graph information in one or more of data stores 464. In the example of FIG. 5, social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 500 by one or more edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “watched” a concept, each of which may correspond to an edge type or subtype. A concept-profile page corresponding to a concept node 504 may include, for example, a selectable “check in” icon (such as, for example, a clickable “check in” icon) or a selectable “add to favorites” icon. Similarly, after a user clicks these icons, social-networking system 460 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 460 may create a “listened” edge 506 and a “used” edge (as illustrated in FIG. 5) between user nodes 502 corresponding to the user and concept nodes 504 corresponding to the song and application to indicate that the user listened to the song and used the application. Moreover, social-networking system 460 may create a “played” edge 506 (as illustrated in FIG. 5) between concept nodes 504 corresponding to the song and the application to indicate that the particular song was played by the particular application. In this case, “played” edge 506 corresponds to an action performed by an external application (SPOTIFY) on an external audio file (the song “Imagine”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “SPOTIFY”).

In particular embodiments, social-networking system 460 may create an edge 506 between a user node 502 and a concept node 504 in social graph 500. As an example and not by way of limitation, a user viewing a concept-profile page (such as, for example, by using a web browser or a special-purpose application hosted by the user's client system 430) may indicate that he or she likes the concept represented by the concept node 504 by clicking or selecting a “Like” icon, which may cause the user's client system 430 to send to social-networking system 460 a message indicating the user's liking of the concept associated with the concept-profile page. In response to the message, social-networking system 460 may create an edge 506 between user node 502 associated with the user and concept node 504, as illustrated by “like” edge 506 between the user and concept node 504. In particular embodiments, social-networking system 460 may store an edge 506 in one or more data stores. In particular embodiments, an edge 506 may be automatically formed by social-networking system 460 in response to a particular user action. As an example and not by way of limitation, if a first user uploads a picture, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 460). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 460 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 460) or RSVP (e.g., through social-networking system 460) to an event associated with the advertisement. In addition or as an alternative, an advertisement may include social-networking-system content directed to the user. As an example and not by way of limitation, an advertisement may display information about a friend of the user within social-networking system 460 who has taken an action associated with the subject matter of the advertisement.

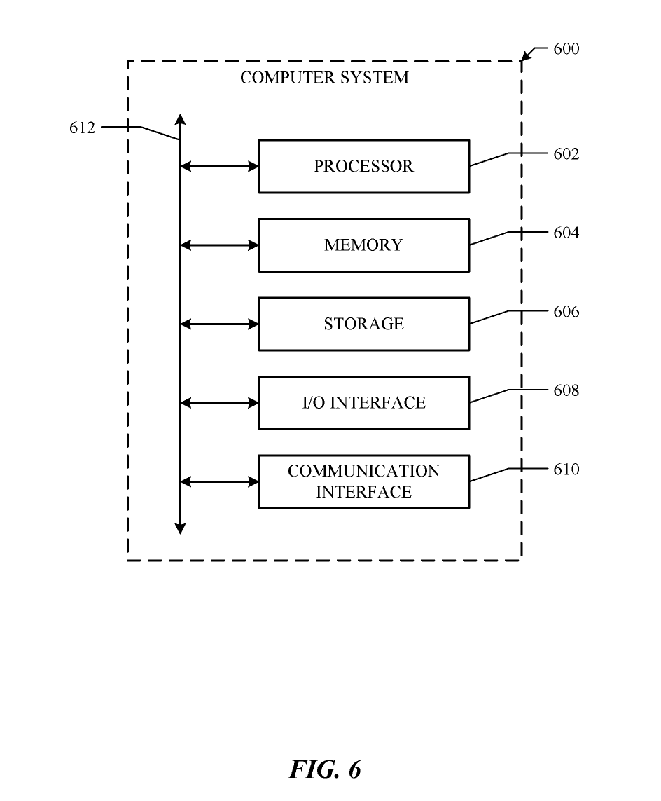

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing device, identifying a first user node that corresponds to a first user of a social-networking system for whom recommendation candidates are to be generated,
wherein the social-networking system comprises a social graph that comprises a plurality of nodes representing users of the social-networking system and a plurality of edges representing relationships between the users, each of the edges connecting two of the nodes and representing a relationship between users who correspond to the nodes;
by the computing device, performing one or more steps of a computation that implements a random walk of the nodes of the social graph, and generates a ranking value for each user node that satisfies one or more constraints, wherein the ranking value represents an importance of the user node to other user nodes in the social graph in accordance with the relationships represented by the edges; and
by the computing device, selecting one or more candidate users to be recommended to a particular user based on the ranking values associated with the user nodes.

2. The method of claim 1, further comprising:
by the computing device, performing one or more steps of the computation that implements the random walk, each step comprising:
for each user node of the social graph:
by the computing device, communicating one or more ranking values stored in association with the user node to each of a first plurality of adjacent nodes that is connected to the user node by an edge, wherein the ranking values comprise a ranking value of the user node, and the communicating causes the ranking values to be stored in association with each adjacent user node; and
when the user node is associated with one or more constraints and satisfies the constraints, determining the ranking value of the user node based on a sum of ranking values received from a second plurality of adjacent user nodes, wherein the ranking values of the adjacent user nodes are stored in association with the user node as a result of the communicating;

3. The method of claim 1, wherein the candidate users to be recommended to the particular user are stored in association with the first user node.

4. The method of claim 1, wherein communicating the one or more ranking values stored in association with the user node to each adjacent node comprises sending a vector comprising the ranking values to each adjacent node.

5. The method of claim 3, further comprising:
by the computing device, receiving one or more vectors from one or more adjacent user nodes of the user node, each of the received vectors comprising one or more ranking values of one or more user nodes; and
by the computing device, calculating an updated ranking value of the user node based on a sum of the ranking values in the received vectors.

6. The method of claim 5, wherein the updated ranking value is calculated by adding a teleport probability to a product of a damping factor and the sum of the ranking values.

7. The method of claim 2, further comprising:
by the computing device, determining whether a stopping condition is satisfied;
when the stopping condition is not satisfied, performing another step of the computation that implements the random walk.

8. The method of claim 1, wherein selecting one or more candidate users to be recommended to a particular user comprises:
identifying a threshold number of the highest-ranking user nodes, wherein the candidate users comprise users corresponding to the threshold number of the highest-ranking user nodes.

9. The method of claim 1, further comprising:
by the computing device, providing identities of the one or more candidate users to a recommendation model configured to select one or more of the candidate users for recommendation to the first user.

10. The method of claim 1, each step further comprising:
by the computing device, retaining at most a threshold number of the highest ranking values between steps of the computation.

11. The method of claim 10, wherein the retaining comprises storing one or more of the highest ranking values in a memory location that is accessible in a next step of the computation.

12. The method of claim 10, further comprising:
by the computing device, deleting ranking values that are less than each ranking value in the threshold number of highest ranking values from memory upon completion of each step of the computation.

13. The method of claim 1, wherein each of the edges represents (1) a follower relationship between the users connected by the edge in which one of the users follows the other user or (2) a friend relationship between the users in which one of the users is friends with the other user.

14. The method of claim 1, wherein the constraint is satisfied by a user node that corresponds to a user who has submitted less than a threshold number of content items to the social-networking system.

15. The method of claim 1, wherein the constraint comprises a new user constraint that is satisfied by a user node that corresponds to a new user.

16. The method of claim 15, wherein the new user joined the social-networking system less than a threshold time in the past.

17. The method of claim 1, wherein the constraint is satisfied by a user node that corresponds to a user who has fewer than a threshold number of followers or friends.

18. The method of claim 1, wherein the constraint is satisfied by a user node connected to another user node by an edge associated with a weight having at least a threshold value, wherein the weight represents a number of interactions.

19. One or more computer-readable non-transitory storage media embodying software that is operable when executed to:
identify a first user node that corresponds to a first user of a social-networking system for whom recommendation candidates are to be generated,
wherein the social-networking system comprises a social graph that comprises a plurality of nodes representing users of the social-networking system and a plurality of edges representing relationships between the users, each of the edges connecting two of the nodes and representing a relationship between users who correspond to the nodes;
perform one or more steps of a computation that implements a random walk of the nodes of the social graph, and generates a ranking value for each user node that satisfies one or more constraints, wherein the ranking value represents an importance of the user node to other user nodes in the social graph in accordance with the relationships represented by the edges; and
select one or more candidate users to be recommended to a particular user based on the ranking values associated with the user nodes.

20. A system comprising: one or more processors; and a memory coupled to the processors comprising instructions executable by the processors, the processors being operable when executing the instructions to:
identify a first user node that corresponds to a first user of a social-networking system for whom recommendation candidates are to be generated,
wherein the social-networking system comprises a social graph that comprises a plurality of nodes representing users of the social-networking system and a plurality of edges representing relationships between the users, each of the edges connecting two of the nodes and representing a relationship between users who correspond to the nodes;
perform one or more steps of a computation that implements a random walk of the nodes of the social graph, and generates a ranking value for each user node that satisfies one or more constraints, wherein the ranking value represents an importance of the user node to other user nodes in the social graph in accordance with the relationships represented by the edges; and
select one or more candidate users to be recommended to a particular user based on the ranking values associated with the user nodes.
